(19) United States
(12) Patent Application Publication
(10) Pub. No.: US 2025/0091030 A1
(43) Pub. Date: Mar. 20, 2025

(54) MULTI-GAS GETTERS

(71) Applicants: Hua Xia, Huffman, TX (US); David DeWire, Superior, CO (US)

(72) Inventors: Hua Xia, Huffman, TX (US); David DeWire, Superior, CO (US)

(21) Appl. No.: 18/964,584

(22) Filed: Dec. 1, 2024

(51) Int. Cl. B01J 20/16; B01D 53/02; B01J 20/28; B01J 20/285

(52) U.S. Cl. CPC B01J 20/165; B01D 53/02; B01J 20/2808; B01J 20/28083; B01J 20/28092; B01J 20/285; B01D 2253/25; B01D 2253/308; B01D 2257/504

(57) ABSTRACT

This disclosure presents multi-phase hierarchical porous nanostructure-based polymer composites and associated getter assemblies designed for scavenging multi-gas and organic compounds outgassed from electronic packages, devices, and modules. The composites integrate hydrophilic microporous, hydrophobic microporous, and hydrophobic mesoporous nanoparticles within a polymer matrix to form binary, ternary, or quaternary multi-phase structures. These polymer composites are utilized to fabricate getter assemblies featuring single-layer, bi-layer, or multi-layer configurations on a substrate. The assemblies are tailored to selectively target specific polar and non-polar gases and organic compounds or to adsorb a broad spectrum of outgassed emissions, irrespective of their polarity, molecular size, or surface energy characteristics.

### FIELD OF THE INVENTION

This invention relates to getters specifically engineered to adsorb both polar and non-polar gases, as well as organic compounds, emitted from electronic packages, devices, and modules. More specifically, it pertains to multi-phase hierarchical porous nanostructured polymer composite-based getters designed to scavenge a wide range of polar and non-polar gases and organic compounds, irrespective of their polarity, molecular size, or surface energy properties.

### BACKGROUND

The reliability of electronic devices is often influenced by the packaging materials used, such as polymers, epoxies, adhesives, and thermal interface materials. These materials can release various gases, including H₂, N₂, O₂, CO, CO₂, CH₄, and volatile organic compounds, as well as various particles, with the emission levels determined by material properties and operating conditions. Elevated temperatures can cause the thermal decomposition of polymers, releasing small molecules such as H₂, CO, CO₂, and CH₄, along with organic compounds. For example, silicone-based materials may emit CH₄ and CO₂, organic compounds (e.g., methanol, ethanol, isopropanol), and hydrocarbons (e.g., methane (CH₄), ethane, propane), while epoxy resins can release CO and CO₂, hydrocarbons (e.g., toluene, benzene, xylene), and organic compounds (e.g., methanol, ethanol, benzyl alcohol). Moisture interacting with adhesives or flux residues can generate H₂ through hydrolysis, while oxidative degradation can produce CO, CO₂, and occasionally SO₂ when sulfur-containing components are present. Additionally, organic compounds such as toluene, xylene, and acetone are often outgassed from adhesives, and RF/MW absorbents can break down into CO, CO₂, and H₂ at elevated temperatures. Entrapped gases like N₂, O₂, and CO₂ and some particles may also be gradually released during operation, especially under vacuum or thermal cycling conditions.

The release of multi-gas emissions (e.g., H₂, N₂, O₂, CO, CO₂, and CH₄), along with various organic compounds (e.g., hydrocarbons (HCs) and volatile organic compounds (VOCs)) of different sizes and polarities, can significantly compromise the reliability of electronic packages. Compounds like CO₂ and organic acids (produced from decomposed organic compounds) can react with moisture to form acidic by-products, leading to corrosion of sensitive metals such as copper and silver in wiring and interconnects. Hydrogen can react with metal oxides, reducing protective passivation layers and making the metals more susceptible to embrittlement and further corrosion. Organic compounds (HCs and VOCs) may condense on critical surfaces, including optical components, MEMS devices, or circuit boards, resulting in contamination that disrupts functionality. Moisture can increase internal humidity, leading to higher leakage currents and potential dielectric breakdown in sensitive components. Outgassed chemicals can degrade adhesives, coatings, and polymer-based components, weakening their mechanical strength and adhesion. Additionally, condensed organic residues on electronic components can reduce light transmission and impair optical performance. Organic residues on component surfaces can also diminish heat dissipation efficiency.

Non-evaporable getters (NEGs) are a well-established solution for controlling outgassing, especially in vacuum systems and analytical instruments. These getters are typically composed of single-phase reactive metals, such as titanium (Ti), zirconium (Zr), tantalum (Ta), vanadium (V), and alloys like Zr—V—Fe, Zr—Al, Zr—Ti—V, and Ti—V—Cr. NEGs primarily operate through chemisorption, where gases chemically react with the getter material to form stable compounds, and sometimes through physisorption on the getter's surface. Zeolite-based getters are another effective solution, particularly for managing outgassing in microelectronic and electronic packages by adsorbing moisture (H₂O) or both moisture and hydrogen (H₂). However, both types of getters are typically limited in scope, targeting specific emission types such as hydrogen and moisture, or combinations of these gases.

Both types of getters, optimized for a limited number of polar or non-polar gases, are ineffective at capturing organic compounds, even in small amounts. While a getter might adsorb some small organic compounds (molecular size <1 nm, and weight <100 g/mol), such as in environments where formaldehyde or acetone are a primary concern; it may still struggle to address larger organic compounds with molecular weights >100 g/mol and molecular sizes >1 nm. For example, sensitive electronic packages often release small organic compounds due to adhesives, coatings, or solvents. However, if a getter is only capable of adsorbing small organic compounds, it may fail in applications where larger organic compounds or aggregates dominate. Therefore, a multi-functional getter capable of adsorbing both polar and non-polar gases, organic compounds across a broad spectrum of molecular sizes is more desirable.

The functional limitations of both types of getters arise from mismatched surface energies relative to many outgassed gases and organic compounds. Zeolites typically exhibit surface energies between 50 and 70 mJ/m², categorizing them as high-surface-energy materials. Similarly, NEGs have surface energies in the range of 50-60 mJ/m², classifying them as medium-to-high-surface-energy materials. In comparison, polar gases like H₂O, CO, CO₂, SO₂, and NH₃ typically have surface energies between 50 and 72 mJ/m², while non-polar gases like H₂, O₂, N₂, and CH₄ fall within the lower range of 18-25 mJ/m². For organic compounds, polar compounds such as acetone, ethanol, isopropanol, and methanol exhibit surface energies between 28 and 45 mJ/m², whereas non-polar organic compounds like toluene, benzene, xylene, propane, and butane range from 20-30 mJ/m².

Given the surface energy ranges of zeolites (50-70 mJ/m²) and NEGs (50-60 mJ/m²), these getters are well-suited for adsorbing high-surface-energy polar gases such as H₂O and CO₂. However, they are less effective at capturing low-surface-energy non-polar gases like H₂, O₂, N₂, and CH₄. While metal oxide doping (e.g., PdO for hydrogen) can enhance selectivity for specific gases, it underscores a significant limitation: current getters cannot comprehensively adsorb the full spectrum of outgassed gases and organic compounds. This limitation arises because the getters' surface energies are substantially higher than those of many non-polar gases and organic compounds. Moreover, relying on a single-surface-energy material restricts versatility, making it difficult to capture a diverse mix of gases and organic compounds without additional enhancements or dopants.

Effectively adsorbing non-polar gases like hydrogen (H₂), oxygen (O₂), and nitrogen (N₂) requires low surface energy levels in the range of 18-25 mJ/m². These low-to-medium surface energy levels enable adsorption primarily through non-specific van der Waals interactions, the dominant mechanism for capturing non-polar gases. In contrast, polar gases such as moisture (H₂O), carbon dioxide (CO₂), and ammonia (NH₃) require medium-to-high surface energies (40-70 mJ/m²) for effective adsorption, relying on stronger polar interactions. A getter with a uniform surface energy—whether low (20-30 mJ/m²), medium (30-40 mJ/m²), or high (40-70 mJ/m²)—is typically limited in function, as it can only effectively adsorb a narrow range of gases. To overcome this limitation, there is a need for getters with varying surface energy structures. Such designs would enable the adsorption of a broader range of outgassed gases and organic compounds, regardless of their polarity, molecular size, and surface energy level.

This invention presents a multi-phase hierarchical porous nanostructured polymer composite with a precisely engineered hybrid surface energy profile. The composite integrates multiple levels of porosity, including micropores and mesopores, each optimized for selective gas adsorption. Hydrophilic micropores with high surface energy are designed to adsorb polar gases. Hydrophobic micropores with low-to-medium surface energy are specialized for capturing non-polar gases and small organic compounds (size <1 nm, weight <100 g/mol). Hydrophobic mesopores are tailored for larger non-polar gases and organic compounds (size >1 nm, weight >100 g/mol), offering expanded pore spaces that enhance adsorption and storage, complementing the micropores' capacity for efficient gas separation and retention.

The multi-phase hierarchical porous nanostructured material of this invention is capable of adsorbing a wide range of gases, including hydrocarbons and organic compounds, irrespective of their polarity, molecular size, or surface energy differences. Each phase within the composite features a distinct porous domain with a tailored surface energy, collectively spanning a comprehensive surface energy range of 20-70 mJ/m². The integration of microporous and mesoporous nanostructures enables the adsorption of outgassed species across diverse polarities and molecular sizes. By incorporating materials with varied surface energy profiles, ranging from 20-70 mJ/m², the design effectively targets both polar and non-polar gases, as well as organic compounds.

### SUMMARY OF THE INVENTION

The terms “invention,” “the invention,” “this invention,” and “present invention” broadly refer to all subject matter disclosed herein, including the claims. Similarly, the terms “polymer composite” and “getter material” are used interchangeably, as are “getter assembly” and “getter.” The term “organic compounds” encompasses both polar and non-polar hydrocarbons (HCs) as well as volatile organic compounds. Additionally, “multiple gases” and “multi-gas” are synonymous, as are “emissions” and “outgassed species.” The terms “high surface energy/low surface energy” and “hydrophilicity/hydrophobicity” are also used interchangeably. Statements using these terms do not limit or restrict the subject matter described or the scope of the claims. The claims themselves define the invention's embodiments, while this summary serves as a high-level overview of key concepts, which are further elaborated in the Detailed Description section. This summary is not intended to specify essential features or limit the scope of the claims, which should be interpreted in light of the entire specification, including the accompanying drawings and individual claims.

The design and development of polymer composite materials for scavenging outgases in electronic packages can be tailored by combining carefully selected phases, each contributing specific functional attributes for the adsorption of targeted gases and organic compounds. A nanoparticle material with a microporous structure, such as zeolites, provides high surface energy domains that are effective for adsorbing polar gases like H₂O and CO₂. In contrast, a nanoparticle material with a mesoporous structure, such as mesoporous silica or alumina, offers larger pore spaces, enhancing the composite's capacity to adsorb non-polar gases and organic compounds. A polymer matrix with low-to-medium surface energy serves as the binding medium for these nanoparticles while optimizing the overall surface energy profile of the composite. This matrix not only ensures mechanical stability and flexibility but also supports the physisorption of non-polar gases such as H₂, O₂, N₂, and various organic compounds.

The multi-phase hierarchical porous nanostructured composite comprises four phases: (1) a hydrophilic microporous nanostructure, (2) a hydrophobic microporous nanostructure, (3) a hydrophobic mesoporous structure, and (4) a polymer matrix with low-to-medium surface energy. The hierarchical porous nanostructure is characterized by multi-level porosity, achieved by embedding microporous and mesoporous nanoparticles into the polymer matrix. This structure maximizes the active surface area and adsorption site density, ensuring that each phase is specialized for targeted adsorption without interference from other phases.

The first-phase material can be selected from aluminosilicates, such as 3A, 4A, 5A, and 13X zeolites, zeolite X, zeolite Y, zeolite A, and natural zeolites. These materials have micropore sizes ranging from 0.3 nm to 2.0 nm and surface energies between 50-70 mJ/m², making them effective for adsorbing polar gases and organic compounds. The second-phase material may include modified zeolites like silicalite-1, ZSM-5, and beta zeolite, which have high Si/Al ratios, surface energies of 30-60 mJ/m², and reduced hydrophilicity. These zeolites balance mesoporosity and hydrophobicity, making them suitable for adsorbing non-polar gases and organic compounds. The third-phase material, with surface energies ranging from 20-80 mJ/m², can be selected from hydrophobic metal-organic frameworks (MOFs), functionalized mesoporous silica (e.g., SBA-15 and MCM-41), activated carbon aerogels, hydrophobic silica aerogels, mesoporous graphene aerogels, and mesoporous alumina. The surface energy of these materials can be modified through functionalization with alkyl, fluorinated, or silane groups. The fourth-phase material, with surface energies ranging from 18-70 mJ/m², can be selected from polymers such as polyvinyl alcohol, silicone RTV, polyimide, epoxy resins, polycarbonate, and polytetrafluoroethylene. This polymer material serves as the matrix to embed the nanoparticles from the first three phases.

In one embodiment, the gettering material integrates both microporous and mesoporous nanoparticles within a tailored polymer matrix, which consists of quaternary or ternary phases. In another embodiment, the microporous nanoparticles are hydrophilic and act as molecular sieves for the adsorption of small polar multi-gases and organic compounds (with molecular sizes <1 nm and molecular weights <100 g/mol). In a further embodiment, the mesoporous nanoparticles are hydrophobic, providing a large surface area and ample void spaces to adsorb larger non-polar multi-gases and organic compounds (with molecular sizes >1 nm and molecular weights >100 g/mol). Additionally, the microporous nanoparticles may also be hydrophobic, functioning as molecular sieves for the adsorption of non-polar gases and organic compounds of smaller sizes (<1 nm and <100 g/mol).

The composite integrates nanostructured micropores and mesopores with varying pore sizes to address diverse adsorption needs. In one embodiment, hydrophilic microporous nanoparticles (less than 100 nm in size with pore dimensions from 0.3 nm to 1 nm) serve as molecular sieves for polar multi-gases and small organic compounds (with sizes <1 nm and molecular weights <100 g/mol). In another embodiment, hydrophobic microporous nanoparticles (also less than 100 nm) function as molecular sieves for non-polar multi-gases and non-polar organic compounds. A further embodiment incorporates hydrophobic mesoporous nanoparticles (less than 100 nm in size with pore dimensions ranging from 2 nm to 50 nm), which efficiently adsorb larger non-polar molecules (with sizes >1 nm and molecular weights >100 g/mol).

The composite also includes a polymer matrix that may be hydrophobic (e.g., polyimide, silicone RTV, polycarbonate, or polytetrafluoroethylene) or hydrophilic (e.g., polyvinyl alcohol or epoxy resins). The selected polymer matrix ensures mechanical integrity, thermal stability, and compatibility with the embedded nanoparticles over a wide temperature range (e.g., −200° C. to 350° C. for PI, −55° C. to 200° C. for silicone RTV, and −50° C. to 150° C. for polyvinyl alcohol and −40° C. to 200° C. for high-temperature epoxy resins). While the polymer matrix provides some adsorption capacity for both polar and non-polar gases and organic compounds, its primary role is to bind the composite together and enhance its durability under varying operational conditions.

To develop a polymer composite capable of adsorbing a broad range of polar and non-polar gases and organic compounds, regardless of their polarities or molecular sizes or surface energy, the design must incorporate hierarchical porosity and optimized surface energy. For seamless integration of all phases within the polymer matrix, the surface energies of the materials in each phase must be precisely tailored. For applications involving small polar gas emissions, the composite is enhanced with hydrophilic microporous nanoparticles with surface energies between 35-45 mJ/m². For environments dominated by small non-polar gases and organic compounds, hydrophobic microporous nanoparticles with surface energies in the range of 35-50 mJ/m² are utilized. For balanced emissions of both polar and non-polar gases and organic compounds, the composite is designed with an optimal surface energy of 35-50 mJ/m². For scenarios dominated by polar multi-gas emissions and organic compounds, the composite incorporates materials achieving a surface energy of 45-60 mJ/m² to ensure effective adsorption across diverse gases.

To enable the polymer composite-based getter to adsorb a wide variety of gases, a multi-phase nanomaterial integration approach is adopted. This multi-phase nanomaterial may consist of 2, 3, or 4 components, each representing an adsorption capacity for specific gas types. Each phase features a distinct porous domain with tailored surface energy, spanning a comprehensive surface energy range of 20-70 mJ/m². Some phases are optimized for polar gases, while others are tailored for non-polar gases or larger organic compounds molecules. This multi-phase architecture ensures efficient capture of a broad spectrum of gases and organic compounds, maximizing adsorption capacity and selectivity without interference among the adsorbed species.

In one embodiment, the adsorbed gases are polar gases, such as H₂O, CO, CO₂, NH₃, and SO₂. In another embodiment, the adsorbed gases are non-polar gases, such as H₂, O₂, N₂, and CH₄. Yet another embodiment targets polar organic compounds, such as methanol, acetone, ethanol, and formaldehyde. Further embodiments focus on non-polar organic compounds, such as benzene, toluene, xylene, hexane, ethylene, and propane.

The polymer composite can be formulated with quaternary or ternary compositions based on the specific application. In one embodiment, the composite consists of 20-60 wt % hydrophilic microporous nanoparticles for polar-dominant gas and organic compounds absorption, 20-60 wt % mesoporous nanoparticles for adsorbing larger non-polar gases (with sizes >1 nm and molecular weights >100 g/mol), and 20-50 wt % polymers. In another embodiment, it includes 20-60 wt % hydrophobic microporous nanoparticles for adsorbing small non-polar gases and organic compounds (with sizes <1 nm and molecular weights <100 g/mol), 20-60 wt % mesoporous nanoparticles for adsorbing larger non-polar gases, and 20-50 wt % polymers. A further embodiment combines 20-60 wt % hydrophilic microporous nanoparticles for polar gases, 20-60 wt % hydrophobic microporous nanoparticles for non-polar gases and organic compounds with small sizes, and 20-50 wt % polymers.

The polymer composite can also be designed with binary compositions. In one embodiment, it contains 30-70 wt % hydrophilic microporous nanoparticles and 30-50 wt % polymers for polar-dominant gas absorption. In another embodiment, the composite comprises 30-70 wt % hydrophobic microporous nanoparticles and 30-50 wt % polymers for adsorbing small non-polar gases and organic compounds. A further embodiment incorporates 20-60 wt % hydrophobic mesoporous nanoparticles and 20-50 wt % polymers for adsorbing larger non-polar gases and organic compounds.

The primary objective of this invention is to develop a single, adaptable getter material capable of efficiently adsorbing a broad spectrum of gases and organic compounds, regardless of their polarity, molecular size, and surface energy characteristics.

Another objective is to provide a multi-phase nanostructured composite material as a multifunctional getter, designed to replace conventional single-phase, single-functional getters. This solution addresses the diverse outgassing challenges encountered across various microelectronic and electronic packages, vacuum systems, and analytical instruments.

This summary highlights the design principles, materials, and fabrication methods for multi-gas getters, as well as the invention's objectives. Full details are provided in the complete disclosure, accompanying figures, and claims.

### BRIEF DESCRIPTION OF THE DRAWINGS

The aspects of the present disclosure are best understood through the detailed description in conjunction with the accompanying figures. These descriptions and drawings are intended to be illustrative and not limiting. Although numerous specific details are provided to offer a thorough understanding of the disclosure, well-known details may be omitted to avoid obscuring the description. Additionally, various modifications to the getter design may be made without deviating from the scope of the embodiments. The invention will be further illustrated with the aid of the following figures, where:

FIG. 1: A ternary diagram illustrating the composition of polymer composites incorporating three phases of porous nanoparticle materials, as described in the invention.

FIG. 2;
FIG. 2(A): The adsorption capacity of outgassed polar gases.
FIG. 2(B): The adsorption capacity of outgassed non-polar gases, achieved by a getter with multi-phase compositions or varying surface energies, as described herein.

FIG. 3: The adsorption capacity of a quaternary polymer composite for polar gases, non-polar gases, and both polar and non-polar organic compounds, according to the embodiments of the invention.

FIG. 4:
FIG. 4(A): A ternary diagram illustrating the composition of polymer composites containing hydrophilic microporous nanoparticles and hydrophobic microporous nanoparticles.
FIG. 4(B): The total adsorption capacity for polar gases, non-polar gases, and both polar and non-polar organic compounds, as described herein.

FIG. 5: The adsorption capacity of a ternary polymer composite for polar gases, non-polar gases, and both polar and non-polar organic compounds, according to the embodiments of the invention.

FIG. 6: The adsorption capacities of binary polymer composites for polar gases, non-polar gases, and both polar and non-polar organic compounds, as described in the embodiments of the invention.

FIG. 7: Cross-sectional views of various embodiments of a single-layer getter, where a polymer composite layer is applied to both sides of a substrate, in accordance with the invention.

FIG. 8: Cross-sectional views of a multilayered getter comprising multiple layers, with each layer featuring a polymer composite containing at least two-phase materials, as described in the invention.

FIG. 9: Cross-sectional views of a bilayer getter, featuring two polymer composite layers applied to opposite sides of a substrate, in accordance with the invention.

FIG. 10: Cross-sectional views of a multi-gas getter with a polymer composite layer applied to the outer surface of a thin metal wire, as described herein.

### DETAILED DESCRIPTION OF THE INVENTION

The embodiments described in this disclosure are illustrative and not restrictive. While specific implementations are provided, alternative forms and materials may be utilized. The structural and functional details outlined here are intended to guide practitioners skilled in the art in applying and adapting the principles described. Features shown in any figure may be combined with those from other figures to create configurations not explicitly detailed. Modifications and combinations consistent with the teachings of this disclosure can be tailored to meet specific applications or requirements.

Polymer composite compositions designed for scavenging outgassed species in electronic packages take advantage of the distinct adsorptive properties of multi-phase nanomaterials. Hydrophilic microporous nanoparticles, such as zeolites, serve as molecular sieves that effectively capture small polar gases due to their structured pores and high surface energy. Hydrophobic microporous nanoparticles, such as modified zeolites, are optimized for small non-polar gases and organic compounds. Hydrophobic mesoporous nanoparticles, including modified silicas, have larger pores that enhance the adsorption of larger non-polar gases and organic compounds. These phases are bound together by a polymer matrix with low-to-medium surface energy, which not only provides mechanical support but also facilitates the physisorption of non-polar gases and organic compounds, improving the overall performance of the composite.

The multi-phase polymer composite integrates diverse nanomaterials with a broad range of surface energies-low (20-30 mJ/m²), medium (30-50 mJ/m²), and high (50-70 mJ/m²). The composite includes:
A hydrophilic microporous nanomaterial (e.g., zeolites) with high surface energy to adsorb polar gases and small polar organic compounds through electrostatic interactions and hydrogen bonding.
A hydrophobic microporous nanomaterial (e.g., modified zeolites) with low-to-medium surface energy, targeting non-polar gases and small non-polar organic compounds.
A hydrophobic mesoporous nanomaterial (e.g., surface-modified silica) with low surface energy specialized for capturing larger non-polar organic compounds.
A polymer matrix (e.g., polyvinyl alcohol, silicone RTV, polyimide, or epoxy resin) with low-to-medium surface energy to bind the nanoparticle phases into a cohesive structure.
   The hierarchical porous nanostructure is achieved by uniformly embedding microporous and mesoporous nanoparticles within the polymer matrix, ensuring optimal interaction with target gases based on their molecular size and polarity.

The use of multi-phase nanomaterials enables the creation of a composite getter capable of capturing a wide range of emitted gases, including organic compounds. While microporous molecular sieve materials like zeolites (e.g., 4A, 5A, or 13X) can achieve adequate adsorption capacity for certain gases, such as moisture (H₂O) and smaller or weakly adsorbed organic compounds, their performance can be limited by molecular size and potential aggregation. At high concentrations, molecules may aggregate into clusters too large for small pores to accommodate. To create a getter that effectively captures a broader spectrum of gases, including larger organic compounds, mesoporous nanoparticles with pore sizes ranging from 1 nm to 50 nm are beneficial. These mesoporous materials increase the available surface area and facilitate the diffusion of larger molecules to adsorption sites, improving overall efficiency. In a hybrid multi-phase composite, mesopores handle larger gases and organic compounds, while microporous nanoparticles capture smaller molecules, providing a balanced and versatile adsorption system.

The polymer matrix functions as both a structural framework and a medium for dispersing nanoparticles, influencing porosity, adsorbent distribution, and interactions with target gases. Depending on its composition, the matrix can contribute to weak physisorption:
Hydrophilic polymers, such as polyvinyl alcohol (34-48 mJ/m²) and epoxy resin (40-50 mJ/m²), enhance the adsorption of polar gases (e.g., H₂O), improving the composite's moisture-scavenging capacity.
Hydrophobic polymers, such as silicone RTV (20-25 mJ/m²), promote the adsorption of non-polar gases while aiding in the selective separation of polar and non-polar species.
Polyimide, a non-polar and thermally stable polymer with its surface energy between 35 and 40 mJ/m², is ideal for capturing non-polar gases in extreme environments.
   By embedding distinct nanoparticle phases within the polymer matrix, a hierarchical porous composite is created. Each phase selectively targets specific gases and organic compounds based on their polarity, surface energy, and molecular size. This integrated approach, combining tailored nanostructures and polymer flexibility, overcomes the limitations of single-phase materials, providing multi-functional gas adsorption capability.

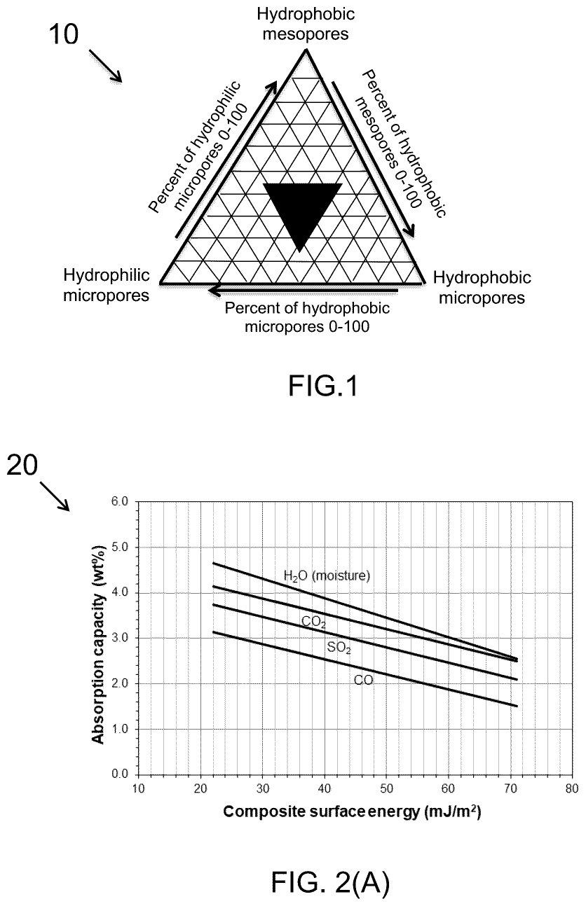

FIG. 1 presents a composition-selection guide for a quaternary material-based composite. In this diagram, each corner represents a specific nanoparticle type, either microporous or mesoporous. These nanoparticles may be hydrophilic or hydrophobic, with the shaded triangular area indicating the optimal composition range for achieving maximum adsorption efficiency. The preferred composition is as follows:
15-45 wt % hydrophilic microporous nanoparticles with their surface energy between 50 and 70 mJ/m².
15-45 wt % hydrophobic microporous nanoparticles with their surface energy between 20 and 40 mJ/m².
15-45 wt % hydrophobic mesoporous nanoparticles with their surface energy between 20 and 30 mJ/m².
A polymer matrix (e.g., polyvinyl alcohol, silicone RTV, polyimide, or epoxy resin) with surface energy of 20-50 mJ/m², provide structural stability and binding the nanoparticle.
   This composition strategically balances surface energy in the range of 20-70 mJ/m², allowing the getter to effectively capture a wide array of gases and organic compounds based on their molecular size and characteristics.

The composite's overall surface energy is calculated as the weighted average of the surface energy E(i) of each component and its mass fraction β(i), using the formula:

$$E ( composite ) = \sum E ( i ) \cdot β ( i ) , \qquad ( 1 )$$

$$i = 1 to n$$

Here, n represents the number of components in the composite; for a quaternary composition, n=4. Using this method, the calculated average surface energy for the described quaternary composition falls within the range of approximately 30-50 mJ/m², which closely matches the surface energy of outgassed gases, enabling effective adsorption across various gases and organic compounds via the different phases of the composite.

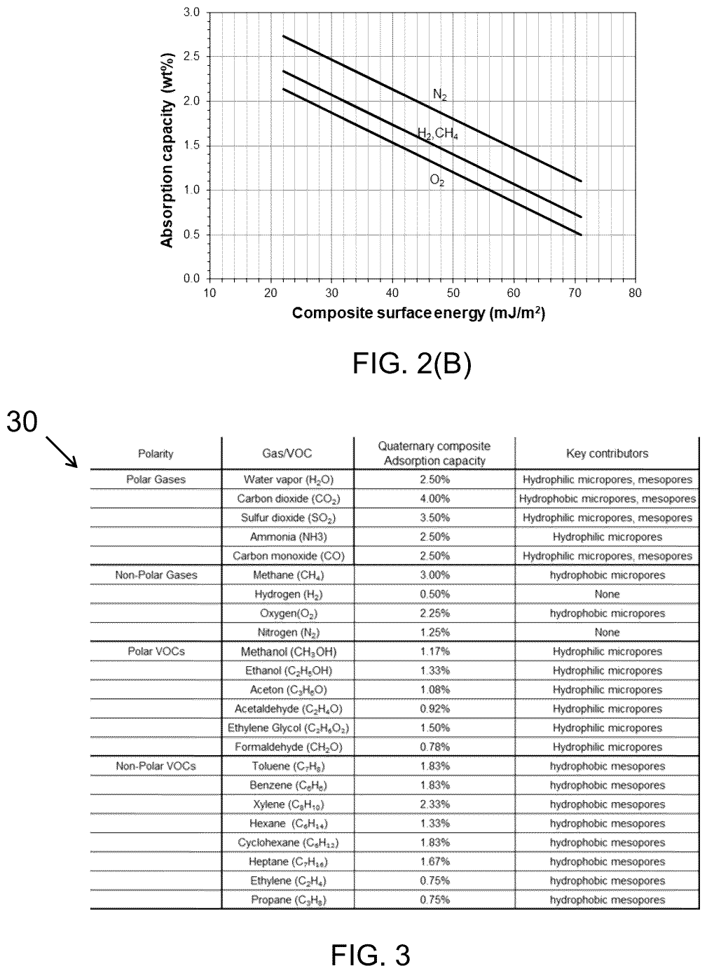

FIG. 2 demonstrates the relationship between adsorption capacity and composite surface energy for various gases. FIG. 2(A) highlights polar gases, including H₂O, CO₂, CO, and SO₂, while FIG. 2(B) focuses on non-polar gases such as H₂, CH₄, O₂, and N₂. Across all gas types, adsorption capacity increases as the composite's surface energy decreases. For example, at a surface energy of 70 mJ/m², water vapor exhibits an adsorption capacity of 2.6 wt %, while CO shows a lower capacity of 1.5 wt % in FIG. 2(A). Among non-polar gases in FIG. 2(B), hydrogen and oxygen display relatively low capacities of 0.7 wt % and 0.5 wt %, respectively.

In hermetically sealed packages, non-polar gases often exhibit insufficient driving forces for adsorption due to their low partial pressures and temperature-induced desorption. Effective adsorption under such conditions requires getter materials with appropriate surface energies. As the composite's surface energy decreases, adsorption capacities improve. Zeolite-based getters, with surface energies typically ranging from 50-70 mJ/m², are highly effective for polar molecules like water vapor but struggle to adsorb non-polar gases such as H₂, N₂, and O₂, despite having microporous sizes of 0.3-1.0 nm. This suggests that adsorption is influenced by surface energy, material phase, and molecular pore size.

FIG. 3 illustrates the predicted adsorption capacity of the four-phase composite for polar gases, non-polar gases, and organic compounds across a surface energy range of 32-48 mJ/m². The adsorption capacities for various gas types are as follows:
Polar gases: 2.5-4.0 wt %
Non-polar gases: 0.50-3.0 wt %
Polar organic compounds: 0.78-1.50 wt %
Non-polar organic compounds: 0.75-2.33 wt %
   Hydrophilic microporous nanoparticles, such as zeolites, enhance the adsorption of polar molecules like water vapor, methanol, ethanol, ammonia, CO₂, and SO₂. Hydrophobic mesoporous nanoparticles help balance moisture control and provide moderate adsorption of both polar and non-polar species. Organic compounds like toluene, benzene, xylene, and acetone exhibit high adsorption capacities (5-7%) due to their compatibility with the composite's microporous, hydrophobic nanostructures, which are particularly effective for aromatic and non-polar hydrocarbons. The composite also shows moderate adsorption for hydrocarbons such as hexane, cyclohexane, propane, as well as non-polar gases like methane and ethylene.

The composite's adsorption performance for hydrogen (H₂) and nitrogen (N₂) is minimal, primarily due to their small size, low polarizability, and weak interactions with the adsorbent materials. These gases lack dipole moments or significant polarizability, which are necessary for strong adsorption, and they are too small to effectively interact with the composite's pore structures. Materials like zeolites, modified zeolites, or modified silica are not specifically designed to adsorb small non-polar gases such as H₂ and N₂. While some minor adsorption may occur, the capacities for these gases are significantly lower compared to those for other gases and organic compounds. In contrast, adsorption is more pronounced for larger or more polar species, such as CO₂, methane (CH₄), or aromatic organic compounds, which interact more strongly with the composite.

Hydrophilic microporous nanoparticles, such as zeolites (20 wt %), primarily adsorb polar gases like H₂O, CO₂, ammonia (NH₃), and smaller organic compounds such as methanol and ethanol. Hydrophobic microporous nanoparticles, like modified zeolites (20 wt %), excel in adsorbing aromatic hydrocarbons and non-polar organic compounds (e.g., toluene, benzene, xylene) due to their hydrophobic nature and pore structures. Hydrophobic mesoporous nanoparticles, such as modified silica (20 wt %), contribute to moisture control and provide moderate adsorption for gases such as carbon monoxide (CO), sulfur dioxide (SO₂), and hydrocarbons. A polymer matrix (40 wt %), such as polyvinyl alcohol, silicone RTV, polyimide, or epoxy resin, provides structural stability and enhances gas diffusion. This composite-based getter achieves a balanced performance, making it well-suited for systems that require both moisture and organic compounds control.

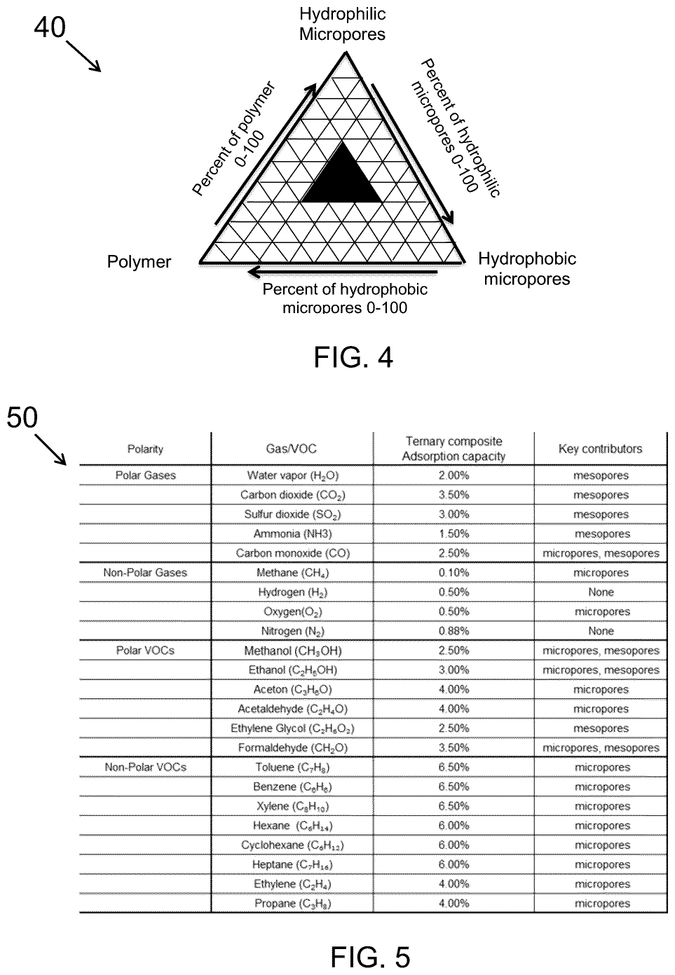

FIG. 4 illustrates a composite with ternary compositions, where each phase occupies a corner. The ideal formulation consists of:
20-50 wt % hydrophilic microporous nanoparticles with surface energies of 50-70 mJ/m²
20-50 wt % hydrophobic microporous nanoparticles with surface energies of 20-40 mJ/m²
30-60 wt % polymers with surface energies of 30-50 mJ/m², such as PVA, silicone RTV, polyimide, or epoxy resin.
   A composite containing 30 wt % hydrophilic microporous nanoparticles, 30 wt % hydrophobic mesoporous nanoparticles, and 40 wt % polymer matrix represents an example of a ternary design. This configuration optimizes the adsorption of non-polar gases and organic compounds, while still providing moderate moisture control, leveraging the complementary adsorption characteristics of low surface energy and hydrophobicity.

Aromatic and non-polar hydrocarbons such as toluene, benzene, xylene, and hexane exhibit the highest adsorption capacities (˜6.5%) due to their affinity for hydrophobic microporous nanostructures. Hydrophobic mesoporous structures contribute moderate adsorption for polar molecules like ethylene glycol and ammonia, while also offering balanced moisture adsorption. Gases such as CO₂, SO₂, and methanol show moderate adsorption capacities (3.0-4.5%), benefiting from both hydrophobic micropores and mesopores. Non-polar gases and organic compounds dominate the adsorption profile, while smaller polar molecules like hydrogen (H₂), ammonia (NH₃), and water vapor (H₂O) exhibit minimal uptake. The hydrophobic microporous phase enhances adsorption of aromatic hydrocarbons, non-polar gases (e.g., methane, ethylene), and ketones (e.g., acetone), whereas the mesoporous phase improves the adsorption of polar gases like CO₂ and SO₂. A 40 wt % silicone RTV polymer matrix ensures structural stability and efficient gas diffusion, making this composite getter suitable for applications requiring moderate moisture control without compromising organic compounds scavenging performance.

Polymer composite design for gas adsorption: polymer composites can be tailored as two-phase systems, combining a polymer matrix with a single type of nanoparticle for specific adsorption needs. Examples include moisture getter:
A composite with 50-60 wt % 3A zeolite and 40-50 wt % polymer matrix effectively adsorbs moisture due to its 0.3 nm pore size.
Polar and Non-Polar Gas Adsorption: A 4A or 5A zeolite-based composite (50-60 wt % zeolite, 40-50 wt % polymer) adsorbs various polar and non-polar gases.
Multi-Gas and organic compounds Getter: A 13X zeolite composite (50-60 wt % zeolite, 40-50 wt % polymer) captures a wide range of gases and organic compounds.

Predicting composite adsorption capacities: to estimate the gas adsorption capacity of composites, such as microporous hydrophilic 13X zeolite embedded in a silicone RTV polymer matrix, follow these steps:

### Step 1: Define Adsorption Properties of Each Component

Zeolite Adsorption: Determine the zeolite's capacity for the target gas or vapor under specific conditions (e.g., temperature, pressure, relative humidity).
Example: 13X zeolites adsorb 25 wt % water vapor at 25° C. and 75% RH.
Polymer Adsorption: Assess the polymer's adsorption capacity for the same gas or vapor.
Example: Silicone RTV adsorbs ˜1 wt % water vapor under similar conditions.

### Step 2: Calculate Weighted Contributions

Use weight fractions to compute the composite's overall adsorption capacity. For a composite with 60 wt % 13X zeolite and 40 wt % silicone RTV: Composite

$$Adsorption Capacity ( wt \% ) = ( 0.6 \times 25 \% ) + ( 0.4 \times 1 \% ) = 15. 4 \% .$$

### Step 3: Adjust for Real-World Factors

Porosity Loss: Account for reduced zeolite surface area due to embedding. If 10% is inaccessible, effective zeolite adsorption decreases to 22.5%. Adjusted

$$Capacity ( wt \% ) = ( 0.6 \times 22.5 \% ) + ( 0.4 \times 1 \% ) = 13. 9 \% .$$

### Step 4: Estimate CO₂ Adsorption

If 13X zeolite adsorbs 20 wt % CO₂ under specific conditions and silicone RTV has negligible adsorption: Composite CO₂ adsorption capacity (wt %)=(0.60×20%)+ (0.40×1%)=12.4%.

This systematic approach ensures accurate predictions of composite adsorption performance.

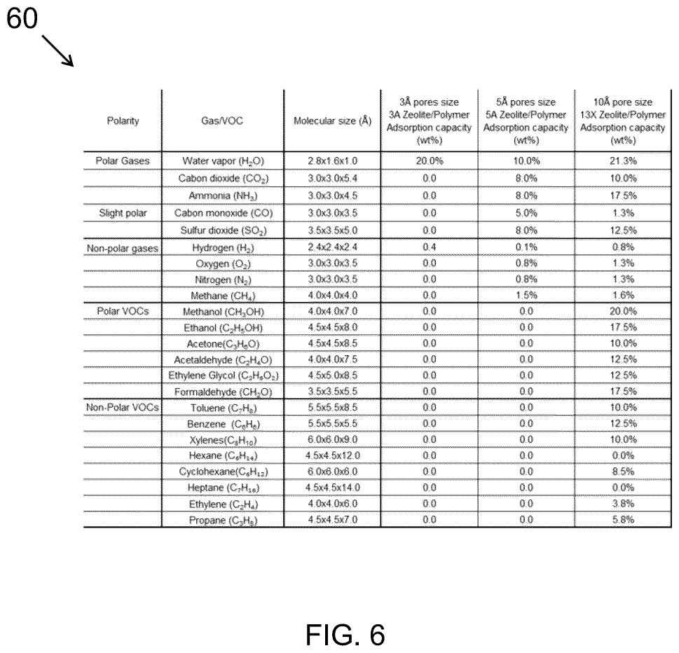

Adsorption capacities for different zeolites: FIG. 6 illustrates gas adsorption capacities of various composites:
3A Zeolite: Adsorbs ˜20 wt % moisture due to its 0.3 nm pore size, with a high affinity for water but limited to moisture adsorption.
5A Zeolite: With a 0.56 nm pore size, it selectively adsorbs smaller molecules like H₂O, CO₂, and NH₃. Larger organic compounds are excluded due to size constraints.
13X Zeolite: Larger pores (1.0 nm) enable adsorption of small polar gases and moderate-sized organic compounds, such as benzene and toluene. However, larger molecular clusters or aggregated organic compounds are challenging to capture.
   These binary composites can be customized for specific applications, such as moisture control (3A), polar/non-polar gas adsorption (5A), or broader organic compounds removal (13X).

Hierarchical porous composites for broad adsorption: Advanced composites incorporate micropores and mesopores to achieve versatile adsorption capabilities:
Micropores (<1 nm): Capture small polar gases like CO₂, NH₃, and H₂O.
Mesopores (2-50 nm): Adsorb larger organic compounds and hydrocarbons.
Hydrophobic nanoparticles enhance non-polar gas adsorption (e.g., CH₄, propane) by minimizing moisture interference. A composite structure combining 20-50 wt % nanoparticles with a polymer matrix (e.g., PVA, silicone RTV, polyimide) ensures:
Balanced adsorption for polar and non-polar gases, with surface energies ranging from 20-70 mJ/m².

Challenges and enhancements in VOC adsorption: Zeolites like 4A, 5A, or 13X can adsorb gases and organic compounds effectively but face limitations with molecular aggregation or steric hindrance. These challenges include:
Molecular Clustering: At high concentrations, organic compounds molecule may form clusters too large for the pores to accommodate.
Steric Hindrance: Even smaller organic compounds may not adsorb efficiently due to weak interactions or poor diffusion.
   To address these issues, hybrid systems combining microporous zeolites (0.3-1 nm) with mesoporous materials (2-50 nm) are preferred. Micropores capture smaller molecules, while mesopores handle larger organic compounds, maximizing overall adsorption efficiency.

In the composite material, the use of larger particles (20-100 μm) can achieve an adsorption capacity of approximately 20 wt % for moisture, thanks to the intrinsic microporous structure of zeolites, which facilitates water molecule entry and adsorption within their pores. However, nanoparticles, due to their smaller size, provide a significantly higher surface area-to-volume ratio compared to micrometer-sized particles. This increased surface area allows for more accessible adsorption sites and shorter diffusion pathways for moisture molecules, potentially improving the adsorption rate. Additionally, nanoparticles often exhibit unique surface chemistry or boundary effects, such as surface defects or elevated surface energy, which can enhance adsorption under certain conditions despite having the same molecular pore size (0.3-1.0 nm).

The choice of binary, ternary, or quaternary phase getters for scavenging gases and VOCs (volatile organic compounds) from electronic packages depends on the desired composition, target molecule range, and synergistic effects among components. Binary Phase Getters: These typically combine two types of nanoparticles, such as hydrophilic microporous and hydrophobic microporous materials, or a single nanoparticle type with a polymer matrix. Hydrophilic microporous nanoparticles efficiently adsorb polar molecules like water due to their strong polar interactions, while hydrophobic microporous nanoparticles are better suited for capturing small non-polar gases or organic compounds. However, without mesoporous structures, binary getters have limited capability to adsorb larger organic compounds molecules or address both hydrophilic and hydrophobic gases simultaneously. Despite this, their straightforward design and manufacturing make binary getters a cost-effective solution for capturing a narrow range of small molecules or polar/non-polar gases.

Ternary Phase Getters: These incorporate three types of nanoparticles-hydrophilic microporous, hydrophobic microporous, and hydrophobic mesoporous-within a polymer matrix. Microporous nanoparticles are adept at capturing smaller gases and organic compounds (0.3-1 nm), including hydrophilic molecules like water and hydrophobic molecules like methane. The inclusion of mesoporous nanoparticles enhances the getter's ability to adsorb larger organic compounds (1-50 nm) that cannot penetrate micropores. This design provides a balance between complexity and performance, making ternary getters ideal for applications requiring the management of both small and large emissions across a diverse range of gases and VOCs.

Quaternary Phase Getters: These combine hydrophilic microporous, hydrophobic microporous, and hydrophobic mesoporous nanoparticles with an additional functional phase, such as catalytic nanoparticles or other materials, embedded in a polymer matrix. This configuration enhances adsorption kinetics and introduces capabilities like catalytic breakdown of organic compounds. The fourth phase also improves stability and nanoparticle dispersion through surface modifiers or binding agents, optimizing gas and organic compounds adsorption across a broad spectrum of sizes and polarities. Quaternary getters are particularly suited for environments with complex gas emissions, such as advanced electronic packages. While their manufacturing process is more intricate than that of binary or ternary getters, quaternary getters offer unparalleled reliability and efficiency, making them ideal for mission-critical applications with a 20-year operational lifespan.

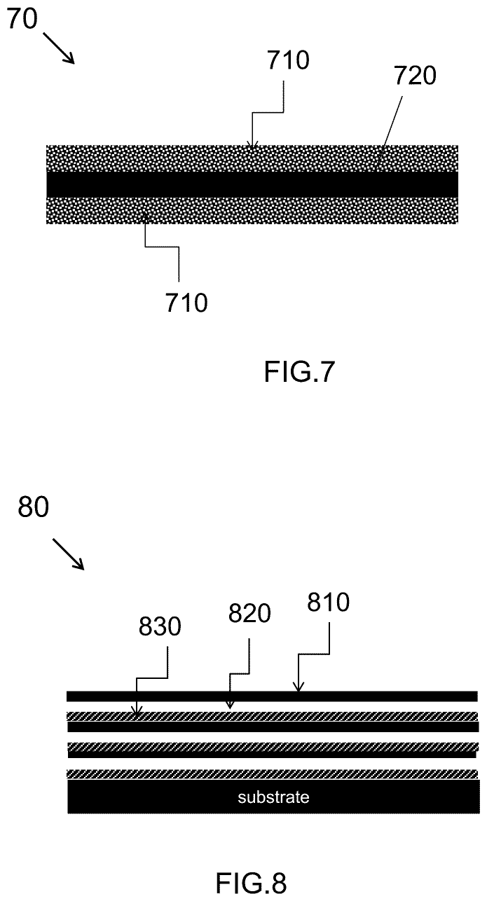

FIG. 7 illustrates a getter assembly (70) comprising a polymer composite layer (710) supported by a substrate (720), such as a thin slab of borosilicate glass, Kovar, or aluminum alloy foil. The composite is applied symmetrically on both sides of the substrate to mitigate thermal stress and prevent film delamination after repeated thermal cycling. This symmetric configuration reduces the net bending moment caused by thermal expansion mismatches between the polymer composite and the substrate, thereby minimizing localized stress concentrations at the interface. By balancing stresses, the adhesive bond between the composite and the substrate is less likely to experience excessive shear forces, ensuring long-term stability. Surface treatments like chemical roughening or plasma treatment can further enhance adhesion between the composite and the substrate, improving durability and reducing the risk of delamination or warping under varying temperature conditions.

FIG. 8 depicts a getter assembly 80 comprising a multilayered polymer composite. The composite includes three distinct phases—810, 820, and 830—applied sequentially to a substrate, with the process repeated until the desired thickness is achieved. The substrate can be a thin slab of borosilicate glass, Kovar, or aluminum alloy. Each layer is customized with specific nanoparticle materials, such as hydrophilic microporous nanoparticles for moisture adsorption, hydrophobic microporous nanoparticles for small non-polar organic compounds, and hydrophobic mesoporous nanoparticles for larger organic compounds. This design enables efficient targeting of a wide range of gases and organic compounds. The multilayer fabrication method ensures high adsorption efficiency, durability, and adaptability, making it ideal for applications requiring robust getters in diverse emission environments.

The layers in the getter assembly 80 offer complementary functions, with the top layer designed to capture larger molecules and inner layers focusing on smaller or more polar molecules. This sequential layering creates a high surface-area-to-volume ratio by dispersing nanoparticles layer by layer. Molecules passing through one layer are captured by subsequent layers, utilizing the full getter thickness for improved adsorption efficiency. The multilayer design also minimizes thermal expansion mismatch stresses, reducing risks of delamination or mechanical failure. Each layer stabilizes the overall structure under thermal or chemical stress, maintaining performance even if one layer becomes saturated or damaged. This approach prevents nanoparticle clustering, ensuring uniform dispersion and eliminating voids or defects that could lower adsorption efficiency. Thin, repeated coatings enhance layer adhesion and robustness, allowing precise control over thickness and performance. Layer composition can also be tailored to prioritize specific gases or operate in extreme conditions, meeting application-specific requirements.

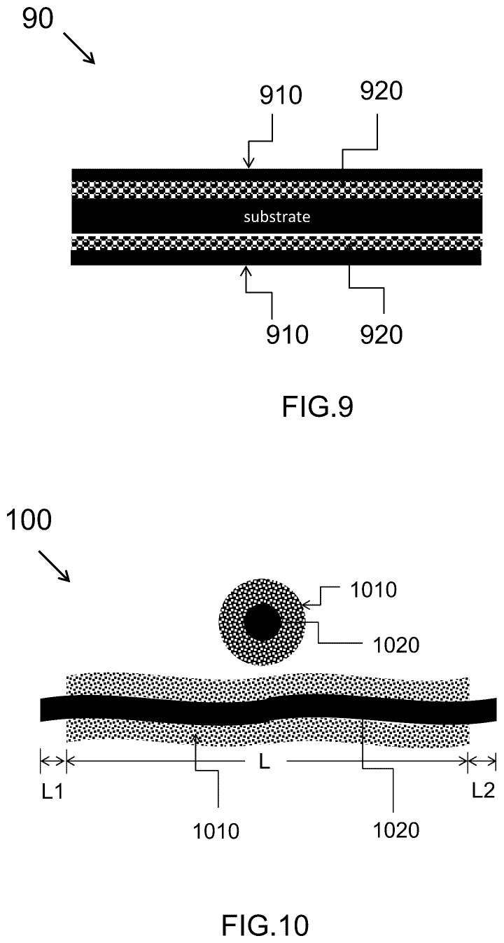

FIG. 9 illustrates a getter assembly 90 with a bi-layered polymer composite structure. Two distinct phases, 910 and 920, are applied to a substrate with a desired thickness. The first layer acts as a molecular filter with small pores, allowing selective diffusion of small molecules into the second layer, which is designed for gas storage, such as moisture. The substrate may include borosilicate glass, Kovar, titanium, or aluminum alloy foils. When the first layer comprises 3A zeolite and the second layer consists of hydrophilic mesoporous silicas, the assembly serves as a high-capacity moisture getter. This design leverages the unique properties of the materials to deliver superior moisture management for long-term or high-demand applications such as electronic packages, aerospace systems, or advanced storage environments.

The binary-phase composite in FIG. 9 uses 3A zeolite in the top layer to act as a molecular sieve, selectively allowing moisture (H₂O) to pass while blocking larger molecules or contaminants that might saturate the internal layer prematurely. Once moisture permeates the top layer, the internal layer of hydrophilic silica, with its highly porous structure and superior adsorption capacity, stores the moisture efficiently. The high porosity of the internal layer (up to 99%) enables substantial storage without rapid saturation, making it ideal for environments with consistent or high humidity. A robust substrate, such as metal or ceramic, enhances mechanical integrity and structural stability, reducing risks of delamination or failure.

In another configuration the getter assembly 90 functions as a high-capacity dual-purpose moisture and hydrogen getter. Here, the first layer is 3A zeolite, the second layer consists of hydrophilic silicas, and the substrate is titanium foil. This design offers superior capacity compared to conventional getters with 3A zeolite or PdO-doped particles. The hydrophilic silica layer provides exceptional surface area for moisture adsorption, while the titanium substrate effectively absorbs hydrogen through hydride formation. The 3A zeolite/polymer top layer acts as a selective barrier, allowing only small molecules like moisture (H₂O) and hydrogen (H₂) to pass through while blocking larger contaminants. This selective filtration reduces fouling and extends the getter's service life. Titanium, a highly efficient hydrogen absorber, forms stable hydrides for durable and long-term hydrogen scavenging, performing effectively at low to moderate temperatures typical of electronic packages. Unlike PdO-based systems that degrade over time, titanium hydrides ensure a stable and reliable hydrogen absorption mechanism, making this assembly ideal for demanding applications.

In a specialized configuration, the getter assembly 90 in FIG. 9 features only a single top layer 910 of 3A zeolite applied on a titanium substrate, omitting the internal layer. This design creates an efficient hydrogen getter with a capacity surpassing conventional 3A zeolite and PdO particle-doped getters or Pd foil-based H₂ getters. Titanium's ability to form stable hydrides (e.g., TiH₂) allows it to absorb and store large amounts of hydrogen efficiently, often exceeding the hydrogen storage capacity of Pd foil, especially in long-term applications. The 3A zeolite layer acts as a molecular sieve, selectively allowing hydrogen to diffuse through to the titanium substrate while blocking contaminants, thereby enhancing getter efficiency. In addition, Titanium offers several advantages in cost efficiency, simplified manufacturing, and thermal stability. Unlike palladium, titanium resists corrosion in harsh environments, making it suitable for demanding applications. This configuration provides a durable, high-performance, and cost-effective hydrogen scavenging solution for various industrial needs.

FIG. 10 depicts a getter assembly 100 in which a polymer composite 1010 coats the outer surface of a metal wire substrate 1020. The wire, which can be made from thin copper, titanium, nickel, or other alloys, offers a high surface-area-to-volume ratio. This geometry maximizes the interaction between the composite getter layer and surrounding gases, enhancing adsorption efficiency. Wire-based getters are versatile and can be configured as coils, meshes, or bundles, increasing the accessible surface area in a compact design. Their small footprint makes them ideal for tight spaces within electronic packages, where they can function as non-electrical components embedded into package walls. The dimensions of the wire can be customized, with lengths tailored for specific applications and diameters ranging from 100 μm to several millimeters. Advantages of wire-based getters include the thin composite layer promotes quick gas diffusion and consistent exposure to gases from all directions, enabling fast adsorption kinetics. In addition, wire length and diameter can be adjusted for application-specific requirements, such as compact designs or PCB integration. This design offers efficient gas adsorption with flexibility for diverse applications.

To fabricate a quaternary or ternary composite film with hydrophilic microporous, hydrophobic microporous, and hydrophobic mesoporous nanoparticles embedded in a polymer matrix and applied onto a substrate, the following steps are employed:

### Nanoparticle Selection:

Hydrophilic Microporous Nanoparticles: 3A, 4A, 5A, 13X zeolites, zeolite X, Y, A, beta-zeolite, and natural zeolites (pore size: 0.3-1 nm).
Hydrophobic Microporous Nanoparticles: Silicalite-1, silicalite-2, ZSM-5, beta-zeolite, and zeolite Y (pore size: 0.3-1 nm).
Hydrophobic Mesoporous Nanoparticles: Alumina, SBA-15, MCM-41, silica aerogels, and activated carbon (pore size: 2-50 nm).
Polymer Matrix: Polyvinyl alcohol (PVA), silicone RTV, polyimide, or epoxy.
Substrate: Metal foils (aluminum, titanium, or copper) or ceramics (e.g., alumina, borosilicate glass).

### Nanoparticle Dispersion:

Disperse nanoparticles into the polymer precursor solution using compatible solvents (e.g., water, ethanol, or acetone).
Add surfactants or dispersants to prevent agglomeration.
Use ultrasonication or high-speed stirring to ensure uniform dispersion.

### Fabrication Methods:

Single-Step Mixing and Coating:
Combine all nanoparticle types into the polymer solution to create a homogeneous suspension.
Apply the suspension onto the substrate using spin, dip, spray, or blade coating techniques.

### Sol-Gel Synthesis:

Mix polymer precursors with nanoparticles to prepare a sol-gel precursor solution.
Coat the substrate via spin or dip coating.
Conduct heat treatment to remove solvents and achieve polymer cross-linking.

The curing and post-fabrication treatment processes include:
Drying: Remove residual solvents at room temperature or low heat (50-100° C.).
Curing: Heat the polymer matrix (e.g., 100-200° C. for polyimides) to enhance mechanical and thermal properties.
Surface Modification: If needed, treat the film surface with a thin layer of hydrophobic nanoparticle-polymer solution to improve hydrophobicity.
   These steps ensure the composite film achieves optimal structural, mechanical, and functional performance.

What is the claimed is:

1. A multi-phase polymer composite comprising:
A hydrophilic microporous phase,
A hydrophobic microporous phase,
A hydrophobic mesoporous phase, and
A polymer matrix phase

2. The polymer composite according to claim 1, wherein the hydrophilic microporous material is selected from one or more of 3A, 4A, 5A, 13X zeolites, zeolite X, zeolite Y, beta-zeolite, natural zeolites, and silica aerogel, with pore sizes ranging from 0.3-50 nm and a surface energy of 30-70 mJ/m².

3. The polymer composite according to claim 1, wherein the hydrophobic microporous material is selected from one or more of silicalite-1, silicalite-2, ZSM-5, beta-zeolite, and zeolite Y, with pore sizes ranging from 0.3-1 nm and a surface energy of 30-60 mJ/m².

4. The polymer composite according to claim 1, wherein the hydrophobic mesoporous material is selected from one or more of alumina, SBA-15, MCM-41, silica aerogels, metal-organic frameworks (MOFs), and activated carbon, with pore sizes ranging from 2-50 nm and a surface energy of 20-80 mJ/m².

5. The polymer composite according to claim 1, wherein the polymer matrix is selected from polyvinyl alcohol, silicone RTV, polyimide, epoxy, polycarbonate, or polytetrafluoroethylene, with a surface energy of 18-70 mJ/m².

6. The polymer composite according to claim 1, wherein the composition includes binary, ternary, or quaternary phases, with an overall surface energy ranging from 20-50 mJ/m².

7. The polymer composite according to claim 1, wherein a ternary-phase composite comprises hydrophobic microporous nanoparticles and hydrophobic mesoporous nanoparticles co-embedded in a polymer matrix, selected from polyvinyl alcohol, silicone RTV, polyimide, epoxy, polycarbonate, or polytetrafluoroethylene, tailored for adsorbing non-polar dominant gases and organic compounds through enhanced hydrophobic interactions and a broad pore size distribution.

8. The polymer composite according to claim 1, wherein a ternary-phase composite comprises hydrophilic microporous nanoparticles and hydrophobic mesoporous nanoparticles co-embedded in a polymer matrix, selected from polyvinyl alcohol, silicone RTV, polyimide, epoxy, polycarbonate, or polytetrafluoroethylene, optimized for adsorbing organic compound-dominant emissions due to their complementary pore size and surface energy interactions.

9. The polymer composite according to claim 1, wherein a ternary-phase composite comprises hydrophobic microporous nanoparticles and hydrophobic mesoporous nanoparticles co-embedded in a polymer matrix, selected from polyvinyl alcohol, silicone RTV, polyimide, epoxy, polycarbonate, or polytetrafluoroethylene, tailored for adsorbing non-polar dominant gases and organic compounds through enhanced hydrophobic interactions and a broad pore size distribution.

10. The polymer composite according to claim 1, wherein a quaternary-phase composite comprises hydrophilic microporous nanoparticles, hydrophobic microporous nanoparticles, and hydrophobic mesoporous nanoparticles co-embedded in a polymer matrix, selected from polyvinyl alcohol, silicone RTV, polyimide, epoxy, polycarbonate, or polytetrafluoroethylene, engineered for adsorbing a wide range of outgassed substances, irrespective of polarity, molecular size, or surface energy characteristics, providing comprehensive gas and organic compounds scavenging capabilities.

11. A getter assembly for scavenging outgassed polar and non-polar gases, as well as organic compounds, from an electronics package, device, or module, comprising:
Single-layered structures,
Bi-layered structures, and
Multilayered structures

12. The getter assembly according to claim 11, wherein the layered structures are coated onto a substrate and contain:
At least one phase of nanomaterials, or
At least two different phases of nanomaterials

13. The getter assembly according to claim 12, wherein the two-phase structure includes at least one nanomaterial selected from hydrophilic microporous, hydrophobic microporous, and hydrophobic mesoporous materials, combined with a polymer matrix selected from polyvinyl alcohol, epoxy resin, silicone RTV, polyimide, polycarbonate, or polytetrafluoroethylene.

14. The getter assembly according to claim 12, wherein the three-phase structure includes at least two nanomaterials selected from hydrophilic microporous, hydrophobic microporous, and hydrophobic mesoporous materials, combined with a polymer matrix selected from polyvinyl alcohol, epoxy resin, silicone RTV, or polyimide, polycarbonate, or polytetrafluoroethylene.

15. The getter assembly according to claim 11, wherein the structure comprises:
A top thin layer of hydrophilic 3A zeolite microporous nanoparticles, and
A middle layer of hydrophobic mesoporous nanoparticles,
as a high-capacity moisture getter

16. The getter assembly according to claim 11, wherein the structure comprises a top thin layer of hydrophilic 3A zeolite microporous nanoparticles coated onto a titanium foil substrate, functioning as a high-capacity hydrogen getter.

17. The getter assembly according to claim 11, wherein the structure comprises:
A top thin layer of hydrophilic 3A zeolite microporous nanoparticles, and
A middle layer of hydrophilic mesoporous nanoparticles,
coated onto a titanium substrate as a high-capacity moisture and hydrogen getter

18. The getter assembly according to claim 11, wherein the structure comprises a polymer composite on a substrate with a composition of at least three phases, optimized as a multi-gas getter for adsorbing polar gases and organic compounds.

19. The getter assembly according to claim 11, wherein the structure comprises a polymer composite on a substrate with a composition of at least four phases, optimized as a multi-gas getter for adsorbing a wide range of outgassed gases and organic compounds, regardless of their surface energy, molecular size, or polarity.

20. The getter assembly according to claim 11, wherein the multilayered structure comprises at least three layers of polymer composite on a substrate, with each layer containing two different phases, forming a high-performance multi-gas getter capable of adsorbing a broad spectrum of outgassed gases and organic compounds, regardless of surface energy, molecular size, or polarity.
